(19) United States
(12) Patent Application Publication
(10) Pub. No.: US 2025/0182356 A1
(43) Pub. Date: Jun. 5, 2025

(54) GENERATIVE ARTIFICIAL INTELLIGENCE PRESENTATION ENGINE IN AN ITEM LISTING SYSTEM

(71) Applicant: eBay Inc., San Jose, CA (US)

(72) Inventors: Richard Vance SIPE, III, Lufkin, TX (US); Antonio HARO, Walnut Creek, CA (US)

(21) Appl. No.: 18/529,143

(22) Filed: Dec. 5, 2023

(51) Int. Cl. G06T 11/60; G06N 3/0475; G06Q 30/0601

(52) U.S. Cl. CPC G06T 11/60; G06N 3/0475; G06Q 30/0643; G06T 2200/24

(57) ABSTRACT

Methods, systems, and computer storage media for providing generative AI presentation management using a generative AI presentation engine in an item listing system. A generative AI presentation engine supports generative AI presentation management based on a generative-AI-data presentation platform including presentation training operations and a presentation data structure for composite image data including images or text. The composite image data and presentation logic are generated using generative AI models. The presentation logic supports mapping and rotating composite image data on item listing system interfaces. In operation, a request associated with image data in an item listing system is accessed. Composite image data associated with a generative AI model and user data is accessed. The composite image data comprises a generative AI image element and a generative AI item listing interface element. The composite image data is communicated to an item listing system client, causing display of the composite image data.

### BACKGROUND

Users can interact with generative artificial intelligence technologies in different types of applications and services to accomplish computing tasks. Generative AI refers to a class of AI systems and algorithms that are designed to generate new data or content that is similar to, or in some cases, entirely different from data they are trained on. Generative AI systems can create support text generation, image generation, music and audio generation, video generation and data synthesis. In particular, generative AI systems can support an item listing system in several ways to improve operational efficiency, customer engagement, and online shopping. For example, an item listing system may employ a generative AI system for content generation (e.g., product descriptions), personalized shopping experiences (e.g., recommendation engines), product discovery (e.g., visual search), and virtual assistants (e.g., chat bots). The item listing system can leverage generative AI through Application Programming Interfaces (APIs), pre-trained models and custom AI solutions to enhance item listing system functionality.

### SUMMARY

Various aspects of the technology described herein are generally directed to systems, methods, and computer storage media for, among other things, providing generative AI presentation management using a generative AI presentation engine in an item listing system. A generative AI presentation engine supports generative AI presentation management based on a generative-AI-data presentation platform including presentation training operations and a presentation data structure for images and text descriptions associated with generative AI models (e.g., image generation models and Large Language Models “LLM”) and item listing system interfaces. In particular, the generative AI presentation engine provides generative AI presentation engine operations (“presentation engine operations”) including training, generating, deploying and integrating, mapping, rotating, and controlling operations that are employed—in combination with the presentation data structure—to improve the presentation of generative AI content on item listing system interfaces.

In operation, a request associated with image data in an item listing system is accessed. Using a generative artificial intelligence (AI) model and user data, composite image data is generated. The generative AI model is associated with presentation training operations and a presentation data structure that support a presentation mapping and rotation system for composite image data. The composite image data comprises two or more of the following: a non-generative AI data element, a generative AI data element, and a generative AI item listing interface element. The composite image data is communicated to an item listing system client to cause display of the composite image data via the item listing system client. A composite image data instruction associated with the composite image data is accessed. Based on the composite image data instruction, updated composite image data is generated. The updated composite image data is communicated to the item listing system client to cause display of the updated composite image data on the item listing system client.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an artificial intelligence system for providing generative AI presentation management in an item listing system, in accordance with aspects of the technology described herein;

FIG. 1C-1F are schematics of an artificial intelligence system for providing generative AI presentation management in an item listing system, in accordance with aspects of the technology described herein;

FIG. 2A is a block diagram of an artificial intelligence system for providing generative AI presentation management in an item listing system, in accordance with aspects of the technology described herein;

FIG. 2B is a block diagram of an artificial intelligence system for providing generative AI presentation management in an item listing system, in accordance with aspects of the technology described herein;

FIG. 3 provides a first exemplary method of providing generative AI presentation management in an item listing system, in accordance with aspects of the technology described herein;

FIG. 4 provides a second exemplary method of providing generative AI presentation management in an item listing system, in accordance with aspects of the technology described herein;

FIG. 5 provides a third exemplary method of providing generative AI presentation management in an item listing system, in accordance with aspects of the technology described herein;

FIG. 6 provides a block diagram of an exemplary item listing system computing environment suitable for use in implementing aspects of the technology described herein;

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION OF THE INVENTION

### Overview

An item listing system and platform support storing items (products or assets) in item databases and providing a search system for receiving queries and identifying search result items based on the queries. An item (e.g., physical item or digital item) refers to a product or asset that is provided for listing on an item listing platform. Search systems support identifying, for received queries, result items from item databases. Item databases can specifically be for content platform or item listing platforms such as EBAY content platform, developed by EBAY INC., of San Jose, California. An item listing system may also provide generative-AI-supported applications (“generative AI applications”) that leverage generative AI models (e.g., image generation models and Large Language Models-“LLM”) to create, generate, or produce content, data or outputs. LLMs are a specific class of generative AI models that are primarily focused on generating human-like text. Generative AI models, like GPT (Generative-Pre-trained Transformer) and its variants, are designed to generate human-like text or other types of data based on the input they receive (e.g., via a prompt interface). These applications use generative AI to perform various tasks across different domains to provide improvement in automation, efficiency, and human-like interaction.

Conventionally, item listing systems are not configured with a comprehensive logic and infrastructure to effectively provide generative artificial intelligence (AI) presentation management for an item listing system. Item listing platform may rely on images that showcase products to potential buyers; however, there are several challenges associated with images on conventional item listing systems. For example, image quality and resolution, image consistency, image descriptions, and image search and discovery. Ensuring high-quality images is essential, but sellers may not always have access to professional photography equipment or skills. Images may not have sufficient resolution to allow buyers to zoom and examine details. Various sellers and products make it challenging to maintain consistent image styles (e.g., inconsistent backgrounds, lighting, and editing styles). Helping users find products through image search can be challenging, as it requires sophisticated algorithms for image recognition and tagging. Moreover, images should be complemented by accurate and information descriptions, and sellers may neglect this, leading to confusion or dissatisfaction among buyers.

Merely implementing conventional imaging technology and descriptions-without a generative AI presentation engine-causes deficient functioning of an item listing system. For example, traditional image processing automation and manual drafting of product descriptions are associated with challenges when trying to efficiently and effectively provide images and descriptions for item listing platforms. Image editing software, responsive design frameworks for devices, feedback, and reporting machines have been implemented; but these solutions lack wide-range adoption because they can be manually intensive with need for expertise from users. Some of these solutions can be time-consuming to develop, they can lack scalability, and can be inconsistent, lacking in real-time feedback, and high in complexity with significant learning curves.

Conventional item listing systems can be improved by addressing these limitations based on automating tasks, providing real-time feedback, improving scalability, and enhancing the accuracy and consistency of image quality, resolution, and descriptions on e-commerce platforms. As such, a more comprehensive item listing system—with an alternative basis for performing item listing system presentation operations—can improve computing operations and interfaces for providing generative AI image management in an item listing system.

Embodiments of the present invention are directed to systems, methods, and computer storage media for, among other things, providing generative AI presentation management using a generative AI presentation engine in an item listing system. A generative AI presentation engine supports generative AI presentation management based on a generative-AI-data presentation platform including presentation training operations and a presentation data structure for images and text descriptions associated with generative AI models (e.g., image generation models and Large Language Models “LLM”) and item listing system interfaces. In particular, the generative AI presentation engine provides generative AI presentation engine operations (“presentation engine operations”) including training, generating, deploying and integrating, mapping, rotating, and controlling operations that are employed—in combination with the presentation data structure—to improve the presentation of generative AI content on item listing system interfaces Generative AI presentation management is provided using the generative AI presentation engine that is operationally integrated into the item listing system associated with an artificial intelligence security system. The artificial intelligence security system supports a generative AI presentation engine framework of computing components associated with presentation engine operations for providing generative AI presentation management.

At a high level, the generative AI presentation engine can be provided as a presentation platform to support presenting images (i.e., image data) and text (i.e., text data) employing generative AI models (e.g., image generation models and LLMs) in an item listing system. The generative AI presentation engine can be a presentation solution that provides presentation engine operations and a presentation data structure associated with providing generative AI presentation management for different interfaces including: seller interfaces, buyer interfaces, and an image composition interface. The presentation solution addresses limitations with traditional presentation technology and includes development of generative AI presentation functionality that improves the functioning of an item listing system. The generative AI presentation engine can implement functional components that provide presentation engine operations including training, generating, deploying and integrating, mapping, rotating, and controlling operations that are employed—in combination with the presentation data structure.

The generative AI presentation engine is responsible for providing generative AI image data or text data. In particular, the generative AI presentation engine provides composite image data that includes an image that is created by combining and layering multiple individual images and text elements or visual components. Composite image data can be created by combining photographs, graphics, illustrations, text or other visual elements to form a single, cohesive image. The composite image data can include non-generative AI data elements and generative AI data elements. The non-generative AI data elements can include pre-existing images or text that are not generated via the generative AI model, while generative AI elements include images or text that are originally created using the generative AI model. The composite image data can include generative AI image elements and generative AI item listing interface elements. The generative AI images elements can include different types of images (e.g., AI images and non-AI images) that are part of the composite image and the generative AI item listing interface elements can includes item listing features (e.g., text, price, title, descriptions, filters, buttons, color pallets, and actions) that are part of the generative composite image. The generative AI presentation engine can include additional features associated with the images. For example, the generative AI presentation engine can support text descriptions for image sets or each image in the image set. The text descriptions may include generative AI text descriptions that provide additional insights (e.g., product highlights) associated with a product in the image and the user.

The generative AI presentation engine can implement presentation composite image data mapping and rotation feature (i.e., presentation mapping and rotation system) designed to generate map and rotate sets of related images. Mapping and rotating of the composite image data can be facilitated by a presentation data structure. For example, the presentation data structure can be a linked data structure of related images and text and sets of images and text that are configured to be presented on different item listing system interfaces. The presentation data structure can further store the presentation logic associated with mapping and rotating the composite image data. In this way, the composite image data can be mapped based on item listing interfaces and rotated based on user interactions.

The presentation mapping and rotation system supports mapping images to portions of an item listing interface and rotating images within image sets, and optionally, to rotate associated text descriptions based on user interactions. The mapping mechanism can support mapping composite image data to item listing system interfaces and specific interface configurations of item listing system interfaces. The rotation mechanism supports the capacity to rotate images within image sets and across image sets, transitioning from one image to another image in response to user interactions. Text rotation is also possible where the text transitions to text descriptions associated with the set of images that is actively displayed for a user. The mapping and rotation can be based on a presentation logic that is associated with interface configurations, user interactions or other variables. The presentation logic is generated via training operations associated with the generative AI model.

The generative AI presentation engine can include image sets associated with a user (e.g., a seller, buyer, or guest user). The image sets can include actual images associated with the user or generative AI images generated based on features (e.g., historical interactions, purchases, images, etc.) associated with the user. For example, a seller may upload images associated with an item for sale, and additional non-AI images and AI images can be associated with the seller in an image set. A first set of images (e.g., image set A) and a second set of images (e.g., image set B) can be associated with each other. In another example, a buyer may have a first set of images associated with items that the buyer previously purchased or owns, and a second set of images associated with recommended items for the buyer. It is contemplated that either set of images can include both non-AI images and AI-images.

The generative AI presentation engine provides training operations and a presentation data structure to support providing generative AI presentation management. Presentation training operations can refer to machine learning training operations that are associated with item listing interfaces (e.g., different configurations of item listing interfaces) and corresponding functionality and services. For example, an item listing system may have a seller interface, buyer interface, and image composition interface that have corresponding interface configurations and features that are associated with functionality of each interface. The training operations include training a generative AI model to understand the different interfaces to generate composite image data and presentation logic for causing display of the composite image data. The item listing interface may include interface configurations and portions such that composite image data is generated with corresponding presentation logic to map the composite image data to the portions of the interface and rotate different composite image data through different interface portions. The interfaces can be associated with item listing interface elements (e.g., title, price, item attributes) that generated and presented based in part on the generative AI model. For example, title, price, item attributes, and filters can be generated as part of the composite image data.

The generative AI presentation engine specifically supports image-based transitions and text-based transitions based on training a generative AI model to generate a set of related images (i.e., image data) and text description (i.e., image data). Composite image data as used herein can refer to the image data or text data that is generated with the generative AI model based on the images and user data associated with a user. The generative AI model is trained to develop the composite image data for the presentation data structure that facilitates storing, communicating, and presenting the composite image data. The generative AI model can be a Generative Adversarial Network (GAN) or a variant designed for image-to-image translation such as CycleGAN or Pix2Pix. The training data set for the image-based transition can include pairs of related images, where each pair represents a transition (e.g., image A1 to image A2) within image set A and Image set B. The pairs can cover various themes or subjects. The text-based transitions can be based on a GPT model (e.g., generative pre-trained transformer) or a variation of GPT that supports generating coherent and contextually relevant text.

As such, the generative AI presentation engine employs a machine learning engine to train one or more generative AI models on item listing system data, operations, and interfaces and further supports deployment and integration into different components and features on the item listing system. For example, the generative AI presentation engine supports an interactive interfaces (e.g., seller and buyer interfaces), an image composition interface, user feedback and control functionality. The generative AI presentation engine uses the presentation data structure and one or more generative AI models to provide generative AI presentation management. It is contemplated that different generative AI models can be generated and employed for different types of presentation engine interfaces. The presentation data structure can support providing different combinations of images (i.e., composite image data) associated with presentation engine interfaces, such that the images are provided on generative AI client. The generative AI client causes display of the composite image data via corresponding interfaces.

Advantageously, the embodiments of the present technical solution support providing generative AI presentation management using a generative AI presentation engine in an item listing system. A generative AI presentation engine supports generative AI presentation based on a generative-AI-data presentation platform including presentation training operations and a presentation data structure for images and text descriptions associated with generative AI models (e.g., image generation models and LLMs) and item listing system interfaces. The generative AI presentation engine operations provide a solution to problems (e.g., image quality and resolution, image consistency, image descriptions, and image search and discovery in an item listing system) in generative AI presentation management. The generative AI presentation engine components, infrastructure, and ordered combination of steps are an improvement over conventional item listing systems that lack support for generative AI presentation management.

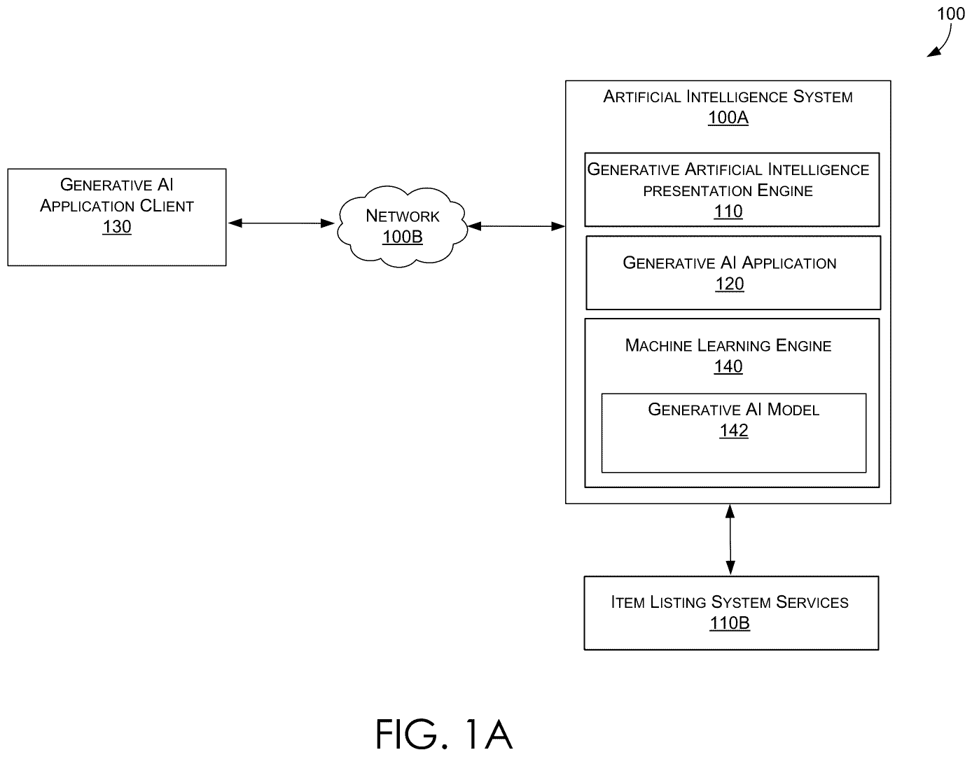

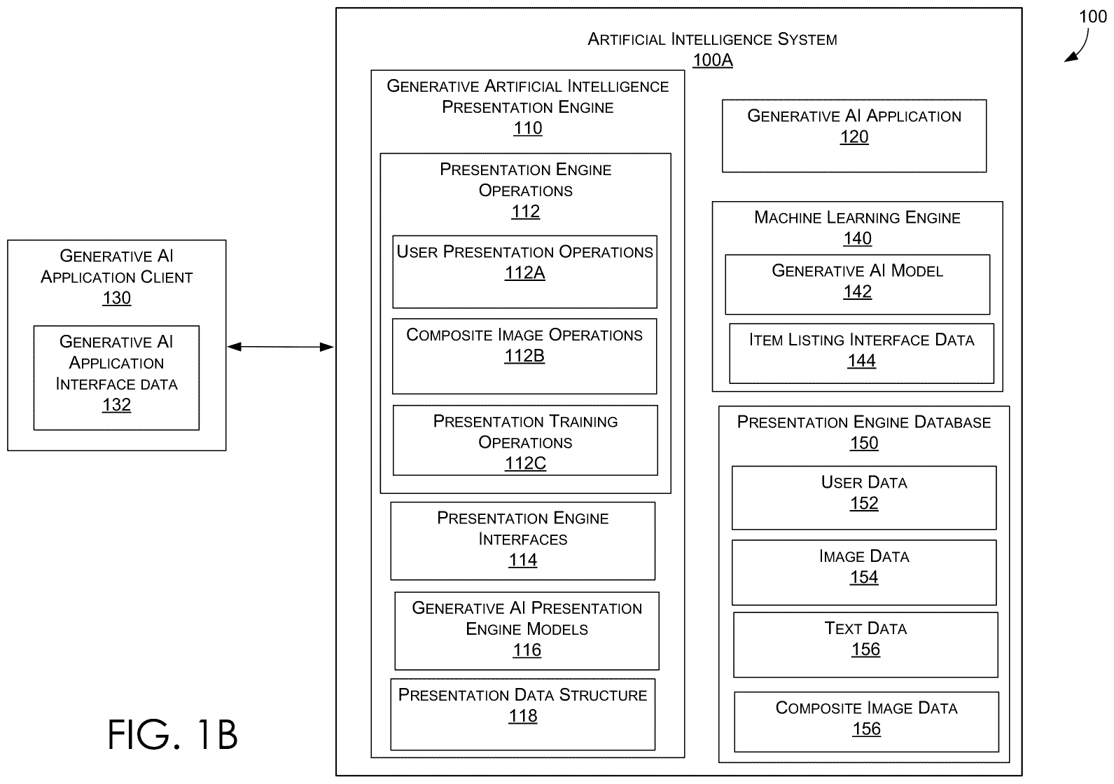

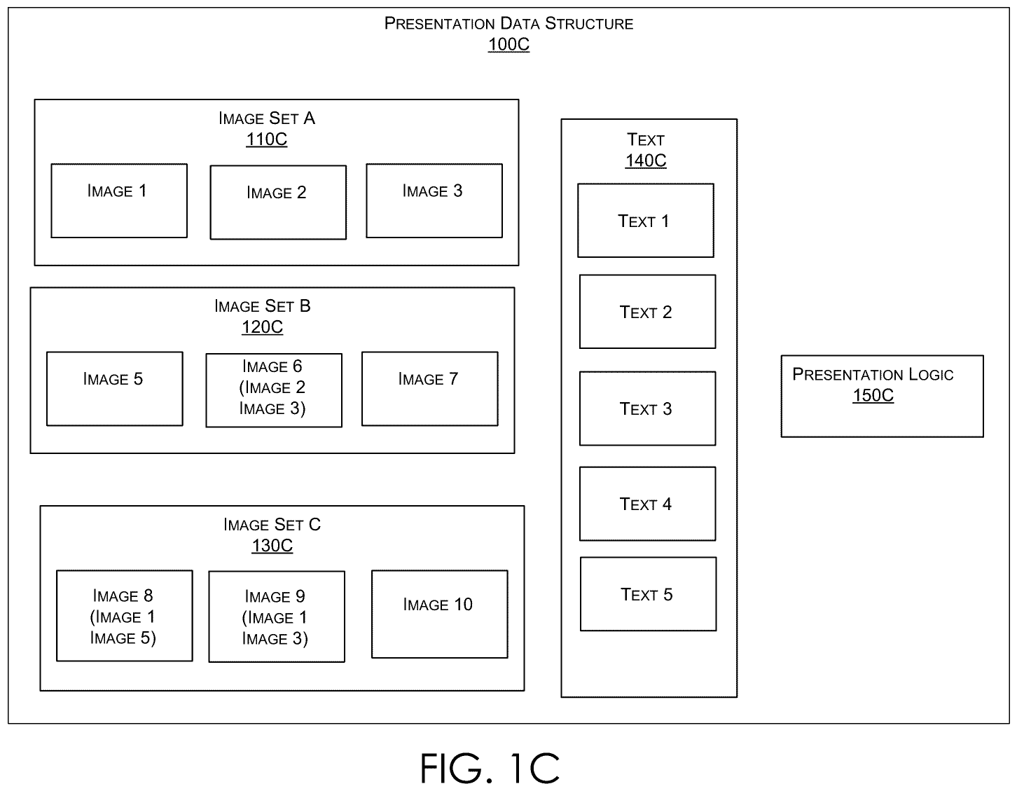

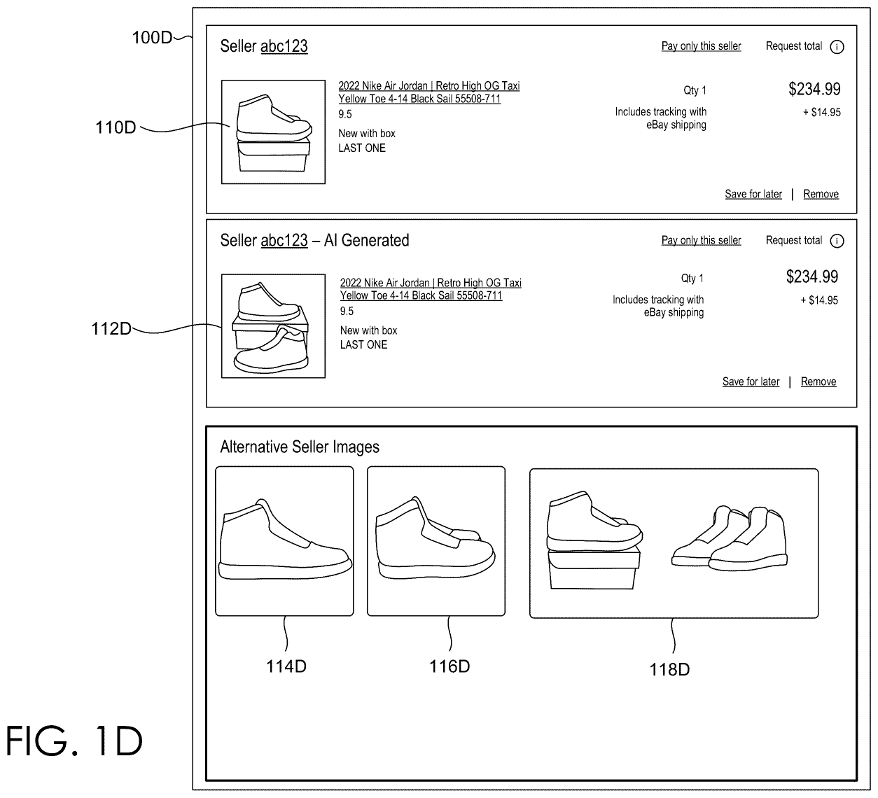

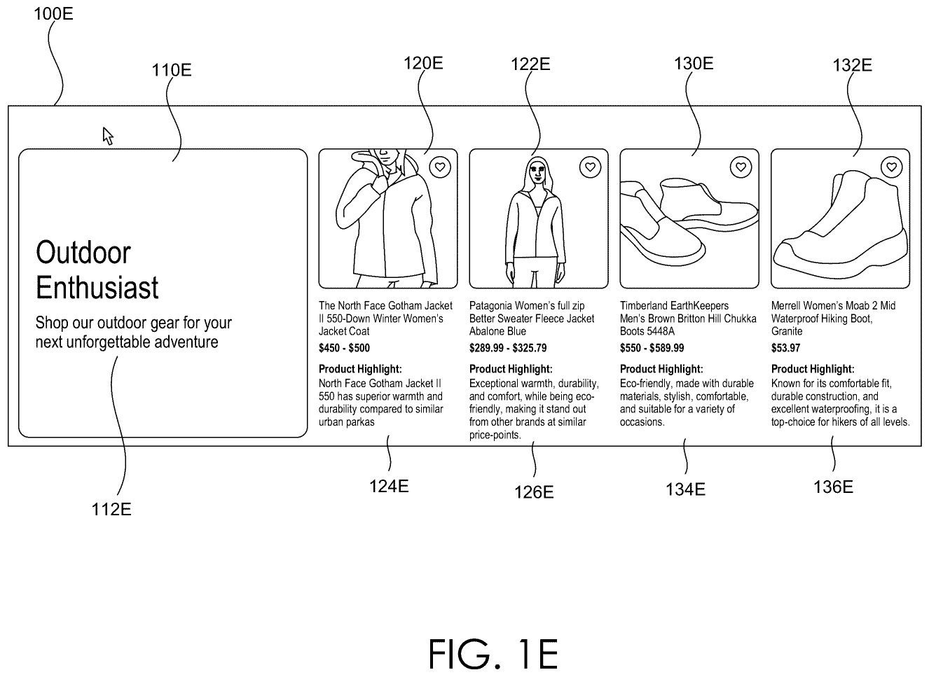

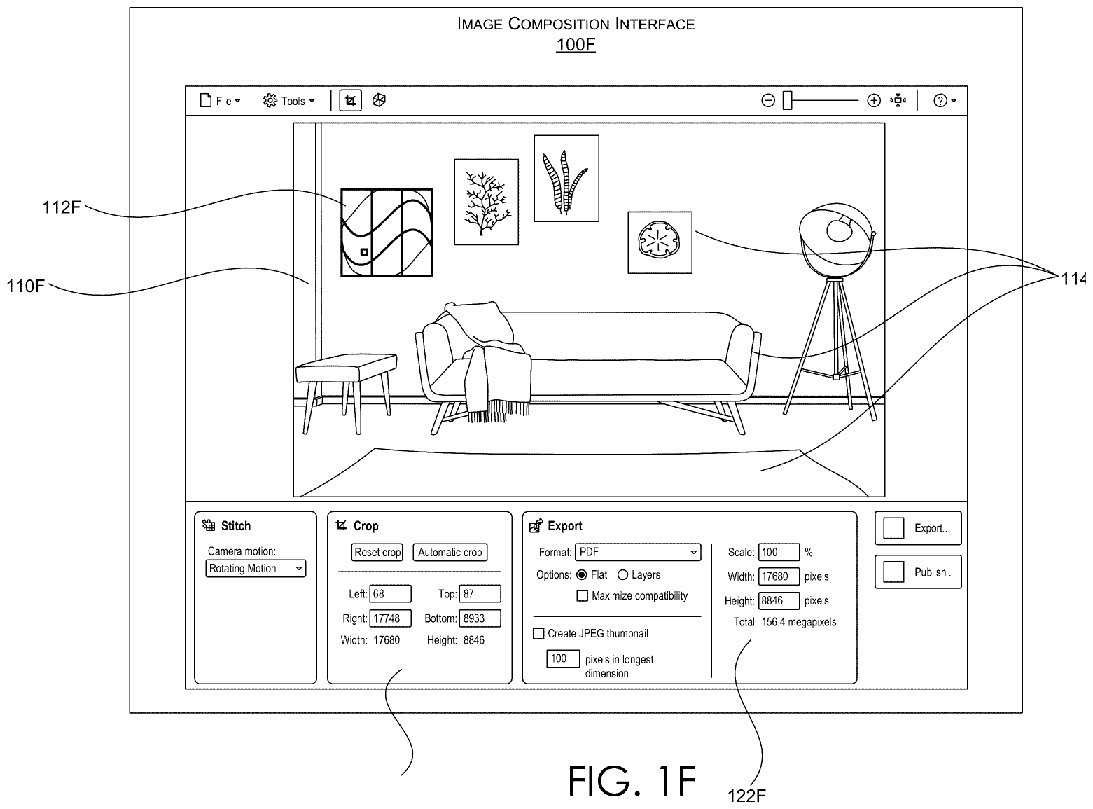

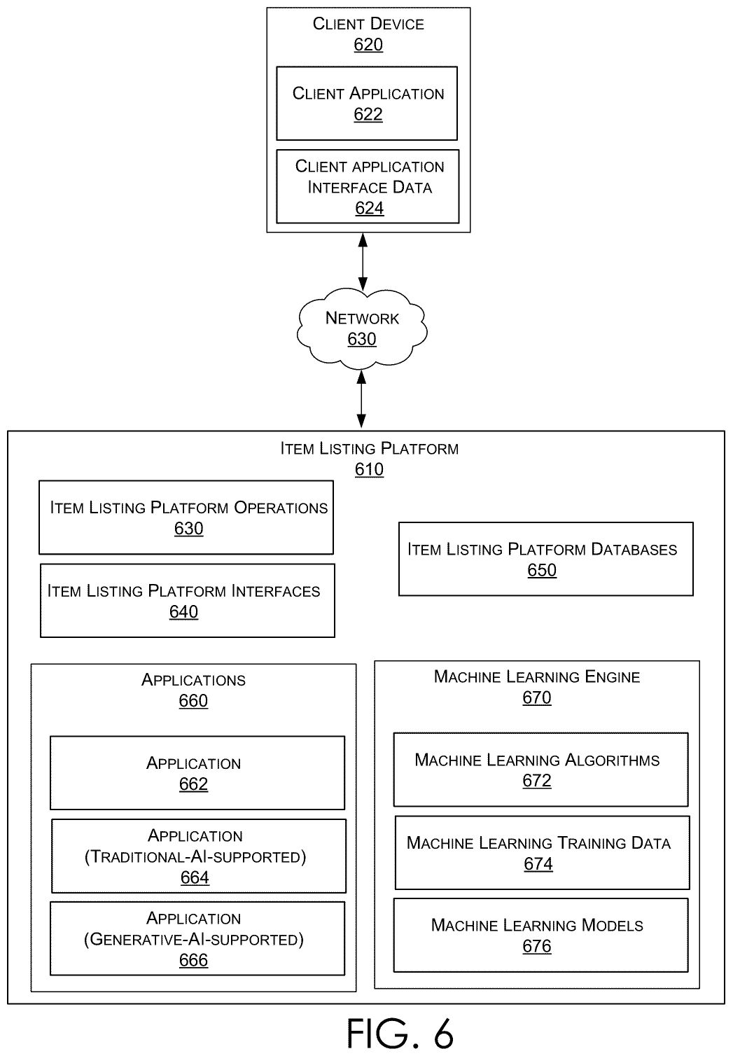

Aspects of the technical solution can be described by way of examples and with reference to FIGS. 1A-1F. FIG. 1A illustrates an item listing system 100 that includes artificial intelligence system 100A, network 100B, generative artificial intelligence (AI) presentation engine 110, generative AI application 120, generative AI application client 130, and machine learning engine 140. The item listing system 100 corresponds to item listing system 600 described below with reference to FIG. 6.

The item listing system 100 provides a system (e.g., artificial intelligence “AI” system 100A) that includes an engine (e.g., generative AI presentation engine 110) for performing operations (e.g., presentation engine operations) discussed herein. The generative AI presentation engine 110 can operate with the generative AI application client 130 (e.g., a client device or item listing system client) that can access the item listing system 100 to execute tasks using a generative AI application 120 associated with a corresponding generative AI model 142. For example, a user—via the generative AI application client 130 (e.g., a prompt interface)—can communicate a request (e.g., a generative AI request having prompt data) to the generative AI application 120 and the generative AI model 142 to process the request. Based on the communicating the request, the generative AI presentation engine 110 can execute presentation engine operations (e.g. training, generating, deploying and integrating, mapping, rotating, and controlling operations) with components of the generative AI presentation engine 110—to ensure processing the request.

Generative AI application client 130 can be associated with seller interfaces, buyer interfaces, and an image composition interface associated with the item listing system. The generative AI application client 130 can cause display of image data, text data, or composite image data based on the generative AI presentation engine 110, the generative AI model 142, and functionality associated with the item listing system 100.

With reference to FIG. 1B, FIG. 1B illustrates artificial intelligence system 100A including generative AI intelligence presentation engine 110 having presentation engine operations 112 including user presentation operations 112A, composite image operations 112B, and presentation training operations 112C; presentation engine interfaces 114; generative AI presentation engine models 116; presentation data structure 118, generative AI application 120; generative AI application client 130 having generative AI client interface data 132; machine learning engine 140 having generative AI model 142 and item listing interface data 144; and presentation engine database 150 including user data 152, image data 156, and text data.

The generative AI presentation engine 110 and the generative AI application client 130 provide graphical user interfaces (i.e., presentation engine interfaces 114 including generative AI application interfaces) and operations (i.e., presentation engine operations). The generative AI presentation engine 110 and the generative AI application client 130 can operate in a server-client relationship to provide generative AI presentation management. For example, a user can communicate a request from the generative AI application client 130 to execute a task via generative AI application 120 and generative AI model 142. Based on the request, the generative AI presentation engine 110 can perform presentation engine operations 112 to ensure processing of the request in the artificial intelligence system 100A.

The generative AI presentation engine 110 may execute presentation engine operations 112 based on a request information on the item listing system 100. A request can be associated with different types of users (e.g., seller user, a buyer user, or a guest user) communicating the request from a client device (e.g., generative AI application client 130). The request can be associated with functionality of the item listing system (e.g., a request associated with listing an item, retrieving a landing page, editing an image, or associated with a search engine, recommendation engine, and generative AI application for the item listing system). The request can be processed such that interface data (e.g., image data, text data, or composite image data) is generated and communicated for presentation via the generative AI application client 130 as generative AI application interface data 132.

The presentation engine database 150 can be configured to store different types of data (e.g., user data 152, image data 154, text data 156, and composite image data). The data can be historical data-including training data for training the generative AI model or new generated data; and the data can further include data that supports generating composite image data or responding to a request associated with image data for the item listing system.

The presentation engine operations 112 can include, by way of example, training a generative AI model on user data, image data, item listing interface data, and a presentation data structure 118 to support generating different types of interface data (i.e., composite image data) for users (e.g., sellers, buyers, and guests); accessing, via the presentation data structure 118, and communicating user data 152, image data 154, text data 156, and composite image data 158 for a user for presentation on different types of interfaces (e.g., item listing interface, searching interface, recommendation interfaces); causing mapping, presentation and rotation of the composite image data based on generative AI presentation engine models and presentation data structure 118 having presentation logic associated with the composite image data; editing composite image data for users via an image composition interface and communicating edited composite image data to one or more the item listing system interfaces. Presentation engine interfaces 114 can support communications between the generative AI presentation engine 110 and the generative AI client application 130, machine learning engine 140, generative AI model 142, and presentation engine database 150. For example, the generative AI presentation engine 110 can receive a request from the generative AI application 120 or communicate composite image data to the generative AI application 120. The generative AI presentation engine 110 can communicate a request to generative AI model 142 and receive a response to the request from generative AI model 142. The generative AI presentation engine 120 can access user data 152, image data 154, text data 156, and generative AI data 158 from the presentation engine database 150.

The generative AI presentation engine 110 is responsible for providing presentation engine operations 112 in the artificial intelligence system 100A. Presentation engine operations can be explained by way illustration with reference to different scenarios. The presentation engine operations 112 include presentation training operations 112C for a generative AI model. Presentation training operations can refer to machine learning training operations that are associated with item listing interfaces and corresponding functionality and services. For example, an item listing system may have a seller interface, a buyer interface, or an image composition interface that includes interface features that support associated functionality of each interface.

The presentation training operations 112 support training a generative AI model (e.g., generative AI model 142 or generative AI presentation engine models 116) to understand the different interfaces and to generate composite image data and presentation logic for causing display of the composite image data. The interfaces can include interface portions such that a generative AI models understands portions of the interfaces and how to generate data for each portion of the interface. As such, presentation training operations 112C can be associated with image generation, variety and realism, smooth transitions, training with pairs, and style control. Presentation training operations 112 can further be associated with historical user data include images, text, purchase, and user interactions (e.g., click behavior) with the item listing system.

A generative AI model (e.g., generative AI model 142 or generative AI presentation engine models 116) can be based on a Generative Adversarial Network (GANs) that supports generating images and a GPT that support generating text. GAN can include two neural networks—a generator and discriminator, where the generator creates images and the discriminator evaluates them. The generative AI model can be trained on a training dataset that include user data (e.g., a seller, a buyer) and images corresponding to the user and other images associated with the item listing system. The generative AI model can further be trained on text data (e.g., historical descriptions of items in the item listing system 100). The generative AI model can specifically be trained for a presentation data structure 118 that is associated with a rotation mechanism for intrinsic rotation and extrinsic rotation of composite image elements associated with composite image data. The generative AI model can be configured to pre-generate output for the presentation data structure 118 such that a rotation mechanism can be used to present and rotate images and text for elements of a composite image generated for the user or a composite image application.

The generative AI model can support the presentation data structure 118 such that the presentation data structure 118 supports efficiently presenting composite image data associated with a user or composite image applications. The presentation data structure 118 can be a hierarchical storage data structure to support storing different related sets of image data, text data, and composite data. The presentation data structure 118 associated with a relational database used to store images and their associated text (e.g., tables for images, text descriptions, and relationships between them) or content addressable storage using an object storage system for storing images and a database or document for storing text. The generative AI model can be trained to generate a variety of related images for a user and the images can be stored along with pre-generated text description variations that can be communicated for display based on the presentation data structure 118. The generative AI model understands and generates content with the necessary attributes for retrieval, presentation, and rotation on an interface.

The presentation engine operations 112 include user presentation operations 112A and composite image operations 112B for presenting generative AI model output on different types of interfaces. For example, seller interfaces can be associated with listing an item and generating output for sellers; buyer interfaces can include landing page interfaces, recommendation interfaces, and searching interfaces support presentation of outputs from the generative AI model; and composite image interface that support editing and composing images and executing item listing functionality form the composite image application interface.

The user presentation operations 112A and composite image operations 112B support retrieving generative AI output associated with the user, such that, the presentation data structure 118 includes composite image data associated with the user. The user presentation operations 112A determine what interface is associated with a request and communicates the composite image data associated with the presentation data structure 118 to the appropriate interface associated with the request. The composite image operations support processing composite image data instructions for composite image data.

Composite image data instructions can refer to input associated with composite image data or interface element associated with composite image data. Input can include actions or interactions from a user that corresponds to an interface of the item listing system. Input may be based on presentation logic associated with the composite image data. For example, the presentation logic may automatically cause generation of input that causes a change to the composite image data. A change to the composite image data can be executed local based on the presentation data structure 118 and additional composite image data. A change to the composite image data can be executed remotely based on communicating the composite image data instruction to the generative AI presentation engine 110.

With reference to FIG. 1C, FIG. 1C illustrates a schematic associated with providing generative AI presentation management using a generative AI presentation engine in accordance with embodiments described herein. FIG. 1C includes presentation data structure 100C includes image set A 110C, image set B 120C, image set C 130, text 140C, and presentation logic 150C. The presentation data structure 100C can be a data structure having a collection of interconnected nodes or elements, where each node contains both data and a reference or link to another node in the data structure. The links define relationships between nodes and allow the creation of complex, dynamic data structures. The image sets can be defined for a particular subset of images including: a set of items being sold by a seller, a set of images bought by a user, or a set of item previous viewed by a user. Another subset of images can be a set of items recommended for a seller to sell, a set of items recommended for a buyer to buy, and a set of composite images (e.g., image 6 based in image 2 and image 3). The set of images can be combined and interconnected as composite images and rotation images based on a rotation logic (e.g., presentation logic 150C) generated via a generative AI model.

The presentation data structure 100C further includes the presentation logic 150C that supports rotating through the different images sets, rotating each image set independently and across images sets based specific criteria (e.g., user actions and timing). The presentation logic 150C can also be associated with text 140C. For example, an item listing system client may cause display of a subset of images and texts from the presentation data structure 100C and rotate through the images sets and text based on the rotation logic for presenting a subset of the images and text. In this way, the image sets or text 140C can be rotated based on user actions that trigger updating a display of content in the presentation data structure 100C.

With reference to FIG. 1D, FIG. 1D illustrates a schematic associated with providing generative AI presentation management using a generative AI presentation engine in accordance with embodiments described herein. FIG. 1D illustrates seller interface 100C that includes seller-provided image 110D, AI-generated image 112D, alternate image 114D, alternate image 116D, and alternate composite image 118D. The generative AI presentation engine 110 and presentation data structure 118 can support generating the seller interface 100D. The seller interface 110C includes seller-provided image 110D (e.g., a photograph taken by the seller of a pair of shoes for sale). The generative AI presentation engine can generate composite image data that includes alternative images that can be provided via the seller interface 100D as alternative seller images. In particular, the generative AI presentation engine can be integrated into an item listing service of an item listing system, such that, an alternative listing and alternative seller images can be automatically or manually generated.

The alternative seller images can include images generated via the generative AI model that is trained to enhance images or generate new images. As such, the seller interface 100D can include alternative image 112D in an AI-generated alternative listing. The alternative image 112D can be based on composite image data. The alternative image 114D and alternative image 116D can be edited and enhanced images, while the alternative composite image 118D can be a composite of different images (non-generative AI images and generative AI images) combined into a single images. A presentation data structure can be associated with the seller interface 100D such that alternative images are efficiently generated, stored, communicated and presented via the seller interface 100D.

With reference to FIG. 1E, FIG. 1E illustrates a schematic associated with providing generative AI presentation management using a generative AI presentation engine in an item listing system 100E. FIG. 1E illustrates buyer interface 100E that includes ad copy text portion 110E, ad copy text 112E, previously bought item 120E, recommended item 122E, product highlight 124E, product highlight 126E, previously bought item 130E, recommended item 132E, product highlight 134E, and product highlight 136E. The generative AI presentation engine and presentation data structure can support generating the buyer interface 110E. The buyer interface 110E include an ad copy text portion 110E that includes ad copy text 112E. The ad copy text can be generated using a generative AI model that is trained to generate user-specific ad copy based on user data, where the ad copy is associated with a plurality of images-including images of previously purchased items, recommended items, and product highlights. The generative AI presentation engine can generate product highlight 124E for previously bought item 120E and product highlight 126E for recommended item 122E; and similarly generate product highlight 134E for previously bought item 130E and product highlight 136E for recommended item 132E.

The images associated with previously bought items and the recommended items can be non-generative-AI images or generative AI-images. In particular, the generative AI-images can be automatically generated to fit a motif associated with the ad copy. The generative AI presentation engine can be integrated into a search service for an item listing system, such that, a buyer interface (e.g., a landing page) can include ad copy, previously bought items, recommended items, and product highlights for the specific user on the buyer interface. A presentation data structure can be associated with the buyer interface 110E such that the ad copy, previously bought items, recommended items, and product highlights are efficiently generated, stored, communicated and presented via the buyer interface 100E.

With reference to FIG. 1F, FIG. 1F illustrates a schematic associated with providing generative AI presentation management using a generative AI presentation engine in an item listing system 100F. FIG. 1F illustrates image composition interface 100F that includes base image 110F, selected item image 112F, unselected item images 114F, first set of image controls 120F and second set of image controls 122F. The generative AI presentation engine and presentation data structure can support generating the image composition interface 100F. The image composition interface 100F includes a base image 110F (e.g., a photograph taken by a user or other base environment for generating a composite image). The generative AI presentation engine can generate composite image data that includes additional images (e.g., selected item image 112F, unselected item images 114F) that can be selected and edited with controls (e.g., first set of image controls 120F, second set of image controls 122F). In particular, the generative AI presentation engine can be integrated into an image composition service of an item listing system, such that, an editable composition image can be generated and provide via the image composition interface 100F.

The base image and additional images (“image composition images”) can include previously bought items, recommended items, and generative AI identified items. The image composition images can be selected or generated via the generative AI model that is trained to provide images composition images for image composition interfaces. The image compositions interface controls can specifically support control features associated with a particular item. For example, item attributes for items in the image composition interface can be selected via the controls and updated on the image composition interface 100F. A presentation data structure can be associated with the image composition images such that the image compositions images are efficiently generated, stored, communicated, and presented via the image composition interface.

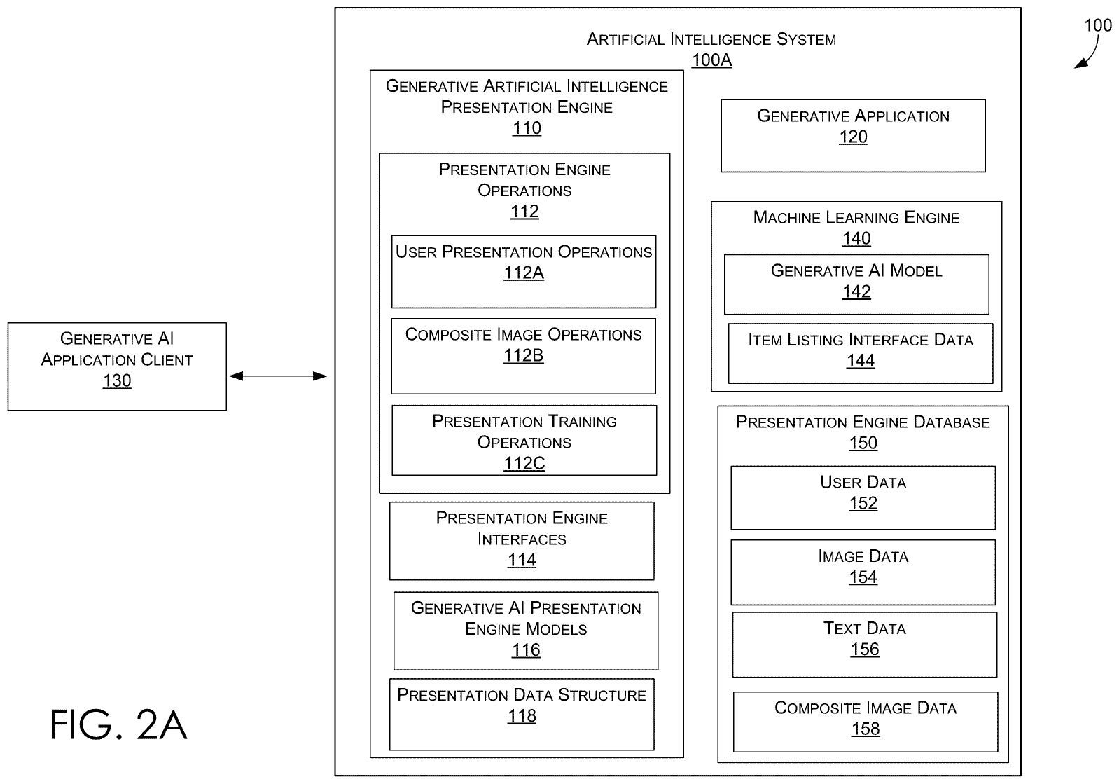

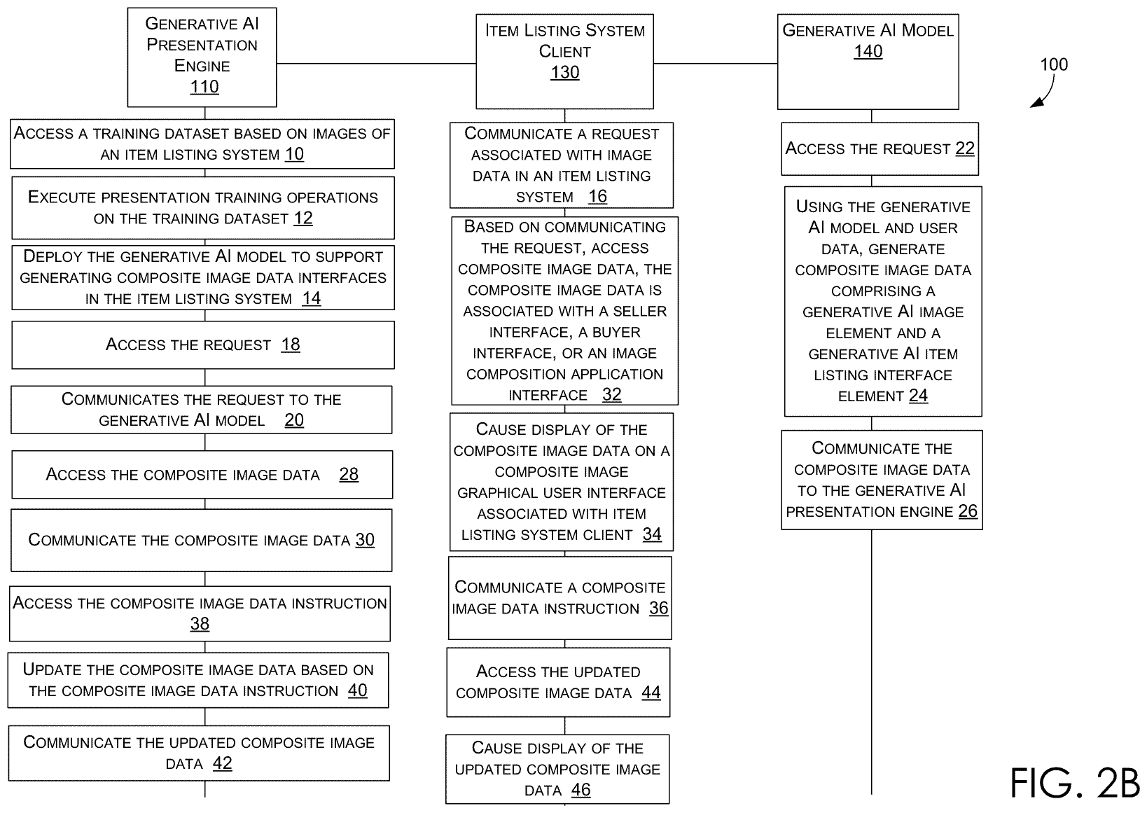

Aspects of the technical solution can be described by way of examples and with reference to FIGS. 2A and 2B. FIG. 2A is a block diagram of an exemplary technical solution environment, based on example environments described with reference to FIGS. 6A, 6B, 7 and 8 for use in implementing embodiments of the technical solution are shown. Generally the technical solution environment includes a technical solution system suitable for providing the example item listing system 100 in which methods of the present disclosure may be employed. In particular, FIG. 2A shows a high level architecture of the item listing system 100 in accordance with implementations of the present disclosure. Among other engines, managers, generators, selectors, or components not shown (collectively referred to herein as “components”), the item list platform system 100 of FIG. 2A corresponds to FIGS. 1A and 1B.

With reference to FIG. 2A, FIG. 2A illustrates an item listing system 100, artificial intelligence system 100A including generative AI intelligence presentation engine 110 having presentation engine operations 112 including user presentation operations 112A, composite image operations 112B, and presentation training operations 112C; presentation engine interfaces 114; generative AI presentation engine models 116; presentation data structure generative AI application 120; generative AI application client 130 having generative AI client interface data 132; machine learning engine 140 having generative AI model 142 and item listing interface data 144; and presentation engine database 150 including user data 152, image data 154, text data 156, and composite image data 158.

The artificial intelligence system 100A includes the generate AI presentation engine 110 that performs operations (e.g., user presentation operations 112A, composite image operations 112B, and presentation training operations 112C). The generative AI presentation engine 110 accesses a training dataset associated with training a generative AI model (e.g., generative AI model 142 for the item listing system). The generative AI presentation engine 110 is associated with a machine learning engine 140 that is associated with training the generative AI models that support image generation and text generation for instances of composite image data. The generative AI presentation causes a machine learning engine 140 to generate the generative AI model 142.

The generative AI model is associated with presentation training operations 112C and presentation data structure 118 that support a presentation mapping and rotation system for composite image data for the item listing system 100. The presentation training operations 112C support training generative AI models based on training data. The training data includes user data 152, image data 154, text data 156 and item listing interfaces data 144. The training operations support generating instances of composite image data for a plurality of item listing interfaces of the item listing system. The presentation data structure 118 includes a presentation logic that includes instructions for mapping composite image data to portions of a corresponding item listing interface.

The generative AI model 142 is associated with generative AI presentation engine 110 that integrates with one or more of the following: an item listing service, a search service, a recommendation service, and an image composition service having corresponding item listing system interface for presenting instances of composite image data for requests processed using the generative AI presentation engine 110. The generative AI presentation engine 110 causes deployment of the generative AI model to support generating composite image data in the item listing system. One or more generative AI models 142 can be deployed as generative AI presentation models 116 in the generative AI presentation engine 110

The generative AI presentation engine 110 accesses a request associated with image data in the item listing system. Based on the request, the generative AI presentation engine 110 accesses composite image data associated with generative AI model. The generative AI presentation engine communicates the composite image data to an item listing system client to cause display of the composite image data via the item listing system client 130. The generative AI presentation engine 130 accesses a composite data instruction associated with the composite image data. Based on the composite image data instruction, the generative AI presentation engine 110 accesses updated composite image data. The generative AI presentation engine 110 communicates the updated composite image data to cause display of the updated composite image data on the item listing system client 130.

The generative AI client 130 communicates a request associated with image data of the item listing system. Based on communicating the request, the generative AI client 130 accesses composite image data. The composite image data is associated with a seller interface, buyer interface or an image composition interface. The composite image data comprises a generative AI image element and a generative AI interface element. The composite image data corresponds to a user associated with the request. The composite image data is generated along with presentation logic using a generative AI model for one or more item listing interfaces of the item listing system. The composite image data further comprises two or more of the following: a non-generative AI data element, a generative AI data element, and a generative AI item listing interface element. The generative AI client 130 causes display of the composite image data. The generative AI client 130 accesses a composite image data instruction. Based on the composite image data instruction, the generative AI client 130 accesses updated composite image data. The updated composite image data is accessed via the presentation data structure that stores a plurality of images or text associated with the composite image data. The generative AI client 130 causes display of the instance of the updated composite image data.

With reference to FIG. 2B, FIG. 2B illustrates generative AI presentation engine 110, generative AI application client 130, and generative AI model 140 for providing generative AI presentation management in an item listing system 100. At block 10, the generative AI presentation engine 110 accesses a training dataset associated based on images of an item listing system to train a generative AI model; at block 12, executes presentation training operations on the training dataset to train the generative AI model; and at block 14, deploys the generative AI model to support generating composite image data interfaces in the item.

At block 16, the generative AI application client 130 communicates a request associated with image data in an item listing system. At block 18, the generative AI presentation engine 110 accesses the request; at block 20 communicates the request to the generative AI model 140. At block 22, the generative AI model 140 accesses the request; at block 24, the generative AI model 140 uses the generative AI model 140 and user data to generate composite image data comprising a generative AI image element and a generative AI item listing interface element; and at block 26, communicates the composite image data to the generative AI presentation engine.

At block 28, the generative AI presentation engine 110 accesses the composite image data; at block 30, communicates the composite image data to the item listing system client 130 to cause display of the composite image data. At block 32, the item listing system client 130, based on communicating the request, accesses the composite image data, the composite image data is associated with a seller interface, buyer interface, or an image composition interface; at block 34, causes display of the composite image data on a composite image graphical user interface associated with the item listing system client; at block 36, communicates a composite image data instruction. At bock 38, the generative AI presentation engine 110 accesses the composite image data instruction; at block 40, updates the composite image data based on the composite image data instruction; and at block 42, communicates the updated composite image data. At block 44, the item listing system client 130 accesses the updated composite image data; and at block 46, causes display of the update composite image data.

### Example Methods

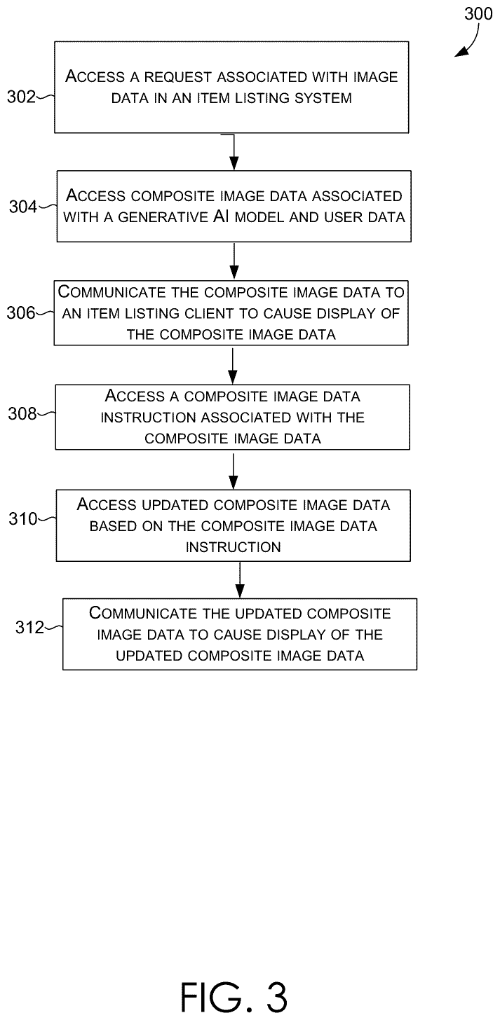

With reference to FIGS. 3, 4, and 5 flow diagrams that illustrate methods for providing generative AI presentation management using a generative AI presentation engine in an item listing system. The methods may be performed using the item listing system described herein. In embodiments, one or more computer-storage media having computer-executable or computer-useable instructions embodied thereon that, when executed, by one or more processors can cause the one or more processors to perform the methods (e.g., computer implemented method) in an item listing system (e.g., computerized system or computer system).

Turning to FIG. 3, a flow diagram is provided that illustrates a method 300 for providing generative AI presentation management using a generative AI presentation engine in an item listing system. At block 302, the generative AI presentation engine accesses a request associated with image data in an item listing system. At block 304, the generative AI presentation accesses composite image data associated with a generative AI model and user data, the composite image data comprising a generative AI image element and a generative AI item listing interface element. The generative AI model is associated with presentation training operations and a presentation data structure that support a presentation mapping and rotation system for composite image data. At block 306, the generative AI presentation engine communicates the composite image data to an item listing system client to cause display of the composite image data via the item listing system client. At block 308, the generative AI presentation engine accesses a composite image data instruction associated with the composite image data. At block 310, the generative AI presentation engine accesses updated composite image data based on the composite image data instruction. At block 312, the generative AI presentation engine communicates the updated composite image data to cause display of the updated composite image data.

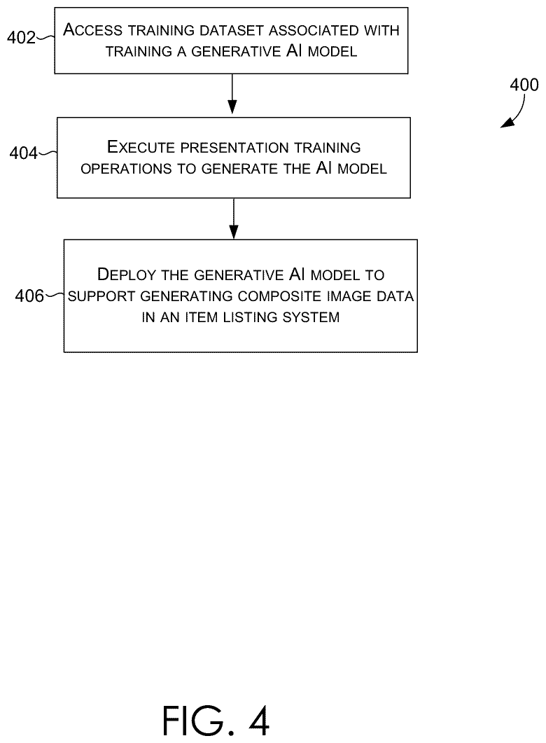

Turning to FIG. 4, a flow diagram is provided that illustrates a method 400 for providing generative AI presentation management using a generative AI presentation engine in an item listing system. At block 402, the generative AI presentation engine accesses a training dataset associated with training a generative AI model. At block 404, the generative AI presentation engine executes presentation training operations to generate the AI model. At block 406, the generative AI presentation engine deploys the generative AI model to support generating composite image data in an item listing system.

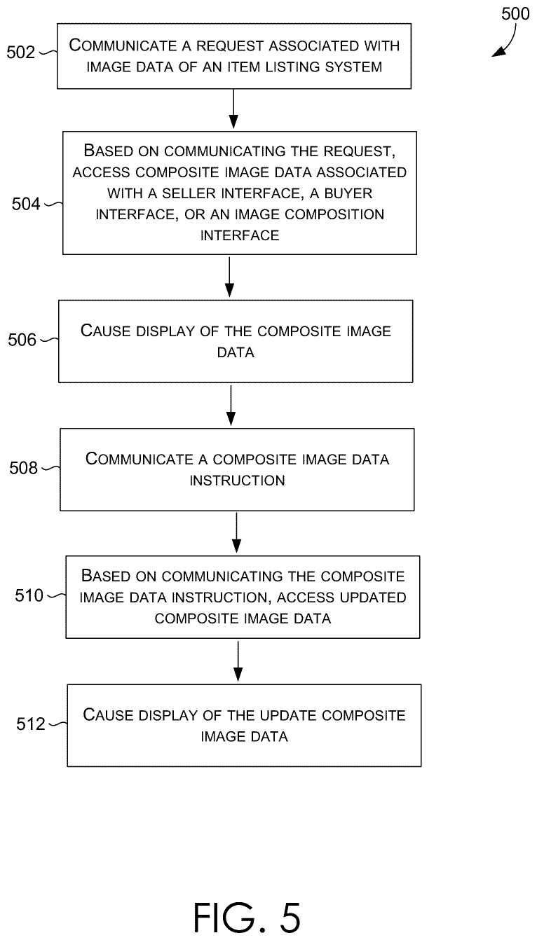

Turning to FIG. 5, a flow diagram is provided that illustrates a method 500 for providing generative AI presentation management using a generative AI presentation engine in an item listing system. At block 502, a generative AI client communicates a request associated with image data of an item listing system. At block 504, based on communicating the request, the generative AI client access composite image data associated with a seller interface, a buyer interface, or an image composition interface. At block 506, the generative AI client causes display of the composite image data. At block 508, the generative AI client communicates a composite image data instruction. At block 510, based on communicating the composite image data instruction, the generative AI client accesses updated composite image data. At block 512, the generative AI client causes display of the updated composite image data.

### Technical Improvement

Embodiments of the present invention have been described with reference to several inventive features (e.g., operations, systems, engines, and components) associated with an item listing system. Inventive features described include: operations, interfaces, data structures, and arrangements of computing resources associated with providing the functionality described herein relative with reference to a hybrid asset management system.

Embodiments of the present invention relate to the field of computing, and more particularly to item listing systems. The following described exemplary embodiments provide a system, method, and program product to, among other things, execute presentation engine operations that provide presentation management using a generative AI presentation engine. Therefore, the present embodiments have the capacity to improve the technical field of item listing platform technology by providing more efficient user interfaces. For example, interfaces described for this technical solution provide a specific improvement over prior systems, resulting in an improved user interface for an item listing system. In particular, the particular manner of summarizing and presenting physical image data do not use conventional user interface methods. The technical solution addresses conventional item listing platforms' lack of integration with a generative-AI-data presentation platform based on improving item listing platform technology by improving user's efficiency in navigating item listing system interfaces.

Functionality of the embodiments of the present invention have further been described, by way of an implementation and anecdotal examples—to demonstrate that the operations for providing generative AI presentation management using a generative AI presentation engine in an item listing system as a solution to a specific problem in item listing platform technology to improve computing operations in item listing systems. Overall, these improvements result in less CPU computation, smaller memory requirements, and increased flexibility in item listing systems when compared to previous conventional item listing system operations performed for similar functionality.

### Additional Support for Detailed Description of the Invention

### Example Item Listing System Environment

Referring now to FIG. 6, FIG. 6 illustrates an example item listing system 600 computing environment in which implementations of the present disclosure may be employed. In particular, FIG. 6 shows a high level architecture of an example item listing platform 610 that can host a technical solution environment, or a portion thereof. It should be understood that this and other arrangements described herein are set forth as examples. For example, as described above, many elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The item listing system 600 can be a cloud computing environment that provides computing resources for functionality associated with the item listing platform 610. For example, the item listing system 600 supports delivery of computing components and services-including servers, storage, databases, networking, applications, and machine learning associated with the item listing platform 610 and client device 620. A plurality of client devices (e.g., client device 620) include hardware or software that access resources on the item listing system 600. Client device 620 can include an application (e.g., client application 622) and interface data (e.g., client application interface data 624) that support client-side functionality associated with the item listing system. The plurality of client devices can access computing components of the item listing system 600 via a network (e.g., network 630) to perform computing operations.

The item listing platform 610 is responsible for providing a computing environment or architecture that includes the infrastructure that supports providing item listing platform functionality (e.g., e-commerce functionality). The item listing platform support storing item in item databases and providing a search system for receiving queries and identifying search results based on the queries. The item listing platform may also provide a computing environment with features for managing, selling, buying, and recommending different types of items. Item listing platform 610 can specifically be for a content platform such as EBAY content platform or e-commerce platform, developed by EBAY INC., of San Jose, California.

The item listing platform 610 can provide item listing operations 630 and item listing interfaces 640. The item listing operations 630 can include service operations, communication operations, resource management operations, security operations, and fault tolerance operations that support specific tasks or functions in the item listing platform 610. The item listing interfaces 640 can include service interfaces, communication interfaces, resource interfaces, security interfaces, and management and monitoring interfaces that support functionality between the item listing platform components. The item listing operations 630 and item listing interfaces 640 can enable communication, coordination and seamless functioning of the item listing system 600.

By way of example, functionality associated with item listing platform 610 can include shopping operations (e.g., product search and browsing, product selection and shopping cart, checkout and payment, and order tracking); user account operations (e.g., user registration and authentication, and user profiles); seller and product management operations (e.g., seller registration and product listing and inventory management); payment and financial operations (e.g., payment processing, refunds and returns); order fulfillment operations (e.g., order processing and fulfillment and inventory management); customer support and communication interfaces (e.g., customer support chat/email and notifications); security and privacy interfaces (e.g., authentication and authorization, payment security); recommendation and personalization interfaces (e.g., product recommendations and customer reviews and ratings); analytics and report interfaces (e.g., sales and inventory reports, and user behavior analytics); and APIs and Integration Interfaces (e.g., APIs for Third-Party Integration).

The item listing platform 610 can provide item listing platform databases (e.g., item listing platform databases 650) to manage and store different types of data efficiently. The item listing platform databases 650 can include relational databases, NoSQL databases, search databases, cache databases, content management systems, analytics databases, payment gateway database, customer relationship management databases, log and error databases, inventory and supply chain databases, and multi-channel databases that are used in combination to efficiently manage data and provide e-commerce experience for users.

The item listing platform 610 supports applications (e.g., applications 660) that is a computer program or software component or service that serves a specific function or set of functions to fulfil a particular item listing platform requirement or user requirement. Applications can be client-side (user-facing) and server-side (backend). Applications can also include application without any AI support (e.g., application 662) application supported by traditional AI model (e.g., application 664), and applications supported by generative AI models (e.g., application 666). By way of example, applications can include an online storefront application, mobile shopping app, admin and management console, payment gateway integration, user account and authentication application, search and recommendation engines, inventory and stock management application, order processing and fulfillment application, customer support and communication tools, content management system, analytics and report applications, marketing and promotion applications, multi-channel integration applications, log and error tracking applications, customer relationship management (CRM) applications, security applications, and APIs and web services that are used in combination to efficiently deliver e-commerce experiences for users.

The items listing platform 610 can include a machine learning engine (e.g., machine learning engine 670). The machine learning engine 670 refers to machine learning framework or machine learning platform that provides the infrastructure and tools to design, train, evaluate, and deploy machine learning models. The machine learning engine 670 can serve as the backbone for developing and deploying machine learning applications and solutions. Machine learning engine 670 can also provide tools for visualizing data and model results, as well as interpreting model decisions to gain insights into how the model is making predictions.

The machine learning engine 670 can provide the necessary libraries, algorithms, and utilities to perform various tasks within the machine learning workflow. The machine learning workflow can include data processing, model selection, model training, model evaluation, hyperparameter tuning, scalability, model deployment, inference, integration, customization, data visualization. Machine learning engine 670 can include pre-trained models for various tasks, simplifying the development process. In this way, the machine learning engine 670 can streamline the entire machine learning process, from data preparation and model training to deployment and inference, making it accessible and efficient for different types of users (e.g., customers, data scientists, machine learning engineers, and developers) working on a wide range of machine learning applications.

Machine learning engine 670 can be implemented in the item listing system 600 as a component that leverages machine learning algorithms and techniques (e.g., machine learning algorithms 672) to enhance various aspects of the item listing system's functionality. Machine learning engine 670 can provide a selection of machine learning algorithms and techniques used to teach computers to learn from data and make predictions or decisions without being explicitly programmed. These techniques are widely used in various applications across different industries, and can include the following examples: supervised learning (e.g., linear regression: classification, support vector machines (SVM); unsupervised learning (e.g., clustering, principal component analysis (PCA), association rules (e.g., apriori); reinforcement learning (e.g., Q-Learning, deep Q-Network (DQN); and deep learning (e.g., neural networks, convolutional neural networks (CNN), and recurrent neural networks (RNN); and ensemble learning random forest.

Machine learning training data 120 supports the process of building, training, and fine-tuning machine learning models. Machine learning training data 120 consists of a labeled dataset that is used to teach a machine learning model to recognize patterns, make predictions, or perform specific tasks. Training data typically comprises two main components: input feature (X) and labels or target values (Y). Input features can include variables, attributes, or characteristics used as input to the machine learning model. Input features (X) can be numeric, categorical, or even textual, depending on the nature of the problem. For example, in a model for predicting house prices, input features might include the number of bedrooms, square footage, neighborhood, and so on. Labels or target values (Y) include the values that the model aims to predict or classify. Labels represent the desired output or the ground truth for each corresponding set of input features. For instance, in a spam email classifier, the labels would indicate whether each email is spam or not (i.e., binary classification). The training process involves presenting the model with the training data, and the model learns to make predictions or decisions by identifying patterns and relationships between the input features (X) and the target values (Y). A machine learning algorithm adjusts its internal parameters during training in order to minimize the difference between its predictions and the actual labels in the training data. Machine learning engine 670 can use historical and real-time data to train models and make predictions, continually improving performance and user experience.

Machine learning engine 670 can include machine learning models (e.g., machine learning models 676) generated using the machine learning engine workflow. Machine learning models 676 can include generative AI models and traditional AI models that can both be employed in the item listing system 600. Generative AI models are designed to generate new data, often in the form of text, images, or other media, based on patterns and knowledge learned from existing data. Generative AI models can be employed in various ways including: content generation, product image generation, personalized product recommendations, natural language chatbots, and content summarization. Traditional AI models encompass a wide range of algorithms and techniques and can be employed in various ways including: recommendation systems, predictive analytics, search algorithms, fraud detection, customer segmentation, image classification, Natural Language Processing (NLP) and A/B testing and optimization. In many cases, a combination of both generative and traditional AI models can be employed to provide a well-rounded and effective e-commerce experience, combining data-driven insights and creativity.

Machine learning engine 670 can be used to analyze data, make predictions, and automate processes to provide a more personalized and efficient shopping experience for users. By way of example, product recommendations search and filtering: pricing optimization, inventory and stock management: customer segmentation, churn prediction and retention, fraud detection, sentiment analysis, customer support and chatbots, image and video analysis, and ad targeting and marketing. The specific applications of machine learning within the item listing platform 610 can vary depending on the specific goals, available data, and resources.

### Example Distributed Computing System Environment

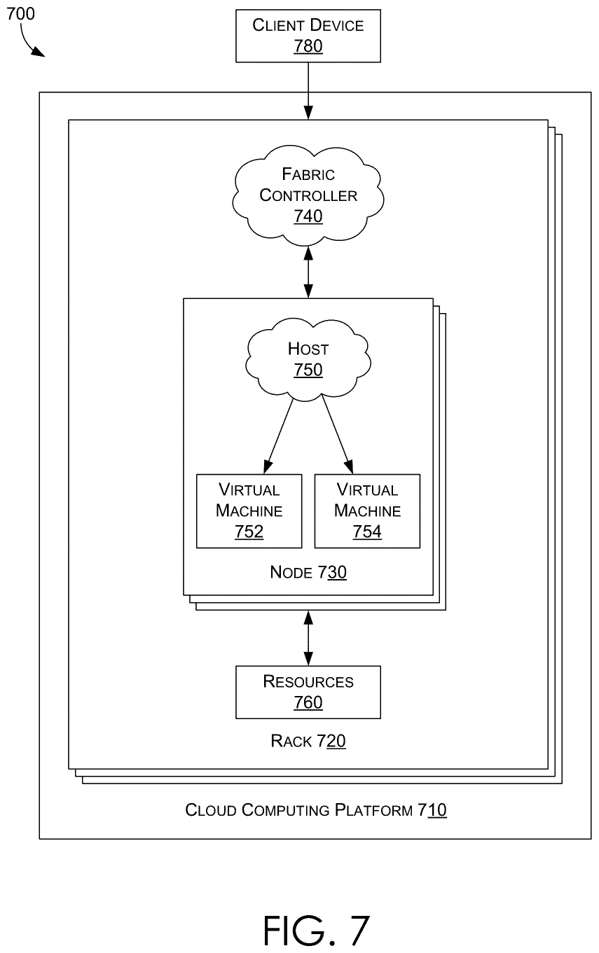

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing infrastructure 710 in a data center can be configured to host and support operation of endpoints of a particular service application. Cloud computing infrastructure 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 700 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

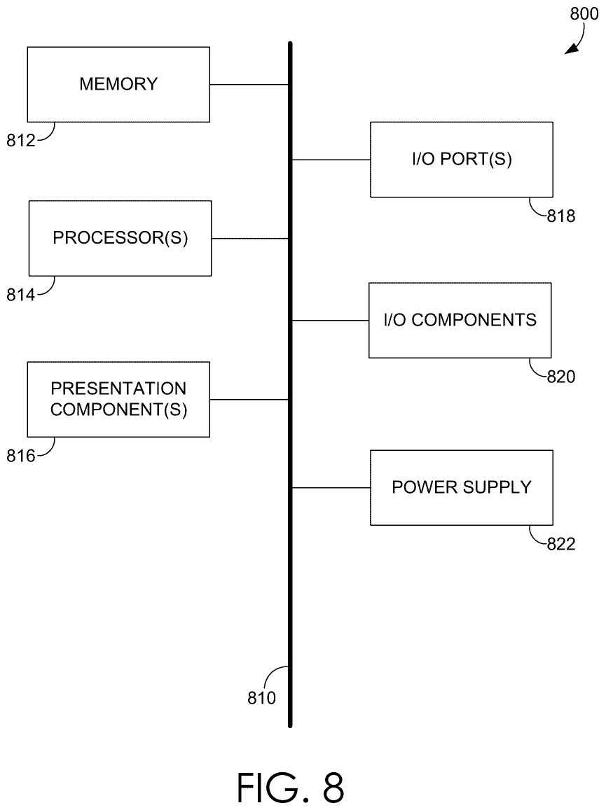

Having briefly described an overview of embodiments of the present invention, an example operating environment in which embodiments of the present invention may be implemented is described below in order to provide a general context for various aspects of the present invention. Referring initially to FIG. 8 in particular, an example operating environment for implementing embodiments of the present invention is shown and designated generally as computing device 800. Computing device 800 is but one example of a suitable computing environment and is not intended to suggest any limitation as to the scope of use or functionality of the invention. Neither should computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code.

Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing a request associated with image data in an item listing system;
based on the request, accessing composite image data associated with a generative AI model, the composite image data comprising a generative AI image element and a generative AI item listing interface element, the generative AI model is associated with presentation training operations and a presentation data structure that support a presentation mapping and rotation system for composite image data for the item listing system;
communicating the composite image data to an item listing system client to cause display of the composite image data via the item listing system client;
accessing a composite image data instruction associated with the composite image data;
based on the composite image data instruction, accessing updated composite image data;
communicate the updated composite image data to cause display of the updated composite image data on the item listing system client.

2. The system of claim 1, further comprising a generative AI presentation engine that integrates with one or more of the following: item listing service, a search service, a recommendation service, and image composition service that support a plurality of item listing system interfaces for presenting instances of composite image data for requests processed using the generative AI presentation engine.

3. The system of claim 1, further comprising a generative AI presentation engine the is associated with a machine learning engine associated with training the generative AI model that supports image generation and text generation for instances of composite image data.

4. The system of claim 1, wherein the presentation training operations support training generative AI models based on training data comprising user data, image data, text data and item listing interfaces data, wherein the training operations support generating instances of composite image data for a plurality of item listing interfaces of the item listing system.

5. The system of claim 1, wherein the presentation data structure comprises a presentation logic that includes instructions for mapping composite image data to portions of a corresponding item listing interface.

6. The system of claim 1, wherein the composite image data corresponds to a user associated with the request, wherein the composite image data is generated along with presentation logic using the generative AI model for one or more item listing interfaces of the item listing system.

7. The system of claim 1, wherein the composite image data comprises two or more of the following: a non-generative AI data element, a generative AI data element, and a generative AI item listing interface element.

8. The system of claim 1, wherein the updated composite image data is accessed via the presentation data structure that stores a plurality of images or text associated with the composite image data.

9. The system of claim 1, the operations further comprising:
communicating a request instance associated with image data of the item listing system;
based on communicating the request instance, accessing an instance of composite image data, the instance of composite image data is associated with a seller interface, a buyer interface, or an image composition interface;
causing display of the instance of composite image data;
accessing an instance of a composite image data instruction;
based on the instance of the composite image data instruction, accessing an instance of updated composite image data; and
causing display of the instance of updated composite image data.

10. The system of claim 1, the operations further comprising:
accessing a training dataset associated with training an instance of a generative AI model;
executing the presentation training operations on the training dataset to generate the instance of the generative AI model; and
deploying the instance of the generative AI model to support generating composite image data interface in the item listing system.

11. One or more computer-storage media having computer-executable instructions embodied thereon that, when executed by a computing system having a processor and memory, cause the processor to perform operations, the operations comprising:
communicating a request associated with image data of an item listing system;
based on communicating the request, accessing composite image data, the composite image data is associated with a seller interface, a buyer interface, or an image composition interface,
the composite image data comprising a generative AI image element and a generative AI item listing interface element, the generative AI model is associated with presentation training operations and a presentation data structure that support a presentation mapping and rotation system for composite image data for the item listing system;
causing display of the composite image data on an item listing system client;
accessing a composite image data instruction;
based on the composite image data instruction, accessing updated composite image data; and
causing display of the updated composite image data on the item listing system client.

12. The media of claim 11, wherein the generative AI model is associated with a generative AI presentation engine that integrates with one or more of the following: item listing service, a search service, a recommendation service, and an image composition service that support corresponding item listing system interfaces for presenting instances of composite image data for requests processed using the generative AI presentation engine.

13. The media of claim 11, wherein the presentation training operations support training generative AI models based on training data comprising user data, image data, text data and item listing interfaces data, wherein the training operations support generating instances of composite image data for a plurality of item listing interfaces of the item listing system.

14. The media of claim 11, wherein the presentation data structure comprises a presentation logic that includes instructions for mapping composite image data to portions of a corresponding item listing interface.

15. The media of claim 11, wherein the composite image data comprises two or more of the following: a non-generative AI data element, a generative AI data element, and a generative AI item listing interface element.

16. A computer-implemented method, the method comprising:
accessing a training dataset associated with training a generative AI model for an item listing system;
executing presentation training operations on the training dataset to generate the generative AI model, the generative AI model is associated with presentation training operations and a presentation data structure that support a presentation mapping and rotation system for composite image data for the item listing system; and
deploying the generative AI model to support generating composite image data in the item listing system.

17. The method of claim 16, wherein the generative AI model is associated with a generative AI presentation engine that integrates with one or more of the following: an item listing service, a search service, a recommendation service, and an image composition service that support corresponding item listing system interfaces for presenting instances of composite image data for requests processed using the generative AI presentation engine.

18. The method of claim 16, further comprising a generative AI presentation engine the is associated with a machine learning engine, wherein the machine learning engine is associated with training the generative AI model that supports image generation and text generation for instances of composite image data.

19. The method of claim 16, wherein the presentation training operations support training generative AI models based on training data comprising user data, image data, text data and item listing interfaces data, wherein the training operations support generating instances of composite image data for a plurality of item listing interfaces of the item listing system.

20. The method of claim 16, wherein the presentation data structure comprises a presentation logic that includes instructions for mapping composite image data to portions of a corresponding item listing interface.
